(19) United States
(12) Patent Application Publication
(10) Pub. No.: US 2010/0015508 A1
(43) Pub. Date: Jan. 21, 2010

(54) CYLINDRICAL SECONDARY BATTERY AND METHOD OF MANUFACTURING THE SAME

(76) Inventor: In-Young Hwang, Gangnam -Gu (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/517,589

(22) PCT Filed: Nov. 21, 2007
(86) PCT No.: PCT/KR07/05874

§ 371 Date: Jun. 4, 2009

(30) Foreign Application Priority Data
Dec. 5, 2006 (KR) 10-2006-0121897

(51) Int. Cl. H01M 2/12; H01M 2/02; H01M 10/04

(52) U.S. Cl. 429/56; 429/164; 29/623.1

(57) ABSTRACT

Provided is a cylindrical secondary battery including a cylindrical exterior can having an open top portion into which an electrode assembly and electrolyte can be inserted and having an electrode tap which is drawn from the electrode assembly and extends upward; and a cap assembly assembled as an integrated structure, having an outer side surface welded and fixed to an inner side surface of an upper portion of the exterior can, and having a bottom surface joined and electrically connected to the electrode tap to transmit electric current generated by the electrode assembly to the outside. In addition, provided is a method of manufacturing a cylindrical secondary battery. The method includes assembling a cap assembly as an integrated structure; inserting an electrode assembly and electrolyte into a cylindrical exterior can having an open top portion; joining and electrically connecting an electrode tap, which is drawn from the electrode assembly, to a bottom surface of the cap assembly; inserting the cap assembly into the open top portion of the exterior can and thus bending the electrode tap; and welding an outer side surface of the cap assembly to an inner side surface Of an upper portion of the exterior can.

### TECHNICAL FIELD

The present invention relates to a cylindrical secondary battery, and more particularly, to a cylindrical secondary battery, which is safer since it does not include a beading portion generally formed in an upper portion of a conventional cylindrical secondary battery and which has a greater electric capacity since the space that could have been occupied by the beading portion can be used to increase its electric capacity, and a method of manufacturing the cylindrical secondary battery.

### BACKGROUND ART

Unlike primary batteries which are not rechargeable, secondary batteries are rechargeable and dischargeable. In recent years, secondary batteries have been widely used in portable electronic devices such as mobile phones and notebook computers. Examples of secondary batteries include nickel-hydrogen batteries, lithium batteries, lithium-ion batteries, and polymer lithium batteries. In addition, secondary batteries are classified into cylindrical secondary batteries, angular secondary batteries, and pouch-type secondary batteries according to shape.

The present invention relates to a cylindrical secondary battery. However, a configuration suggested in the present invention is not limited to the cylindrical secondary battery. Those of ordinary skill in the art will readily apply the configuration of the present invention to an angular secondary battery and a pouch-type secondary battery.

FIG. 1 is a cross-sectional view of a conventional cylindrical secondary battery. The conventional cylindrical secondary battery and a method of manufacturing the same will now be described with reference to FIG. 1. Referring to FIG. 1, two rectangular plate-type electrodes and a separator, which is interposed between the two electrodes and prevents a short circuit between the two electrodes, are stacked and then rolled up like a jellyroll to form an electrode assembly 20. A positive electrode tap 22 is drawn upward from the electrode assembly 20, and a negative electrode tap (not shown) is connected to an outer wall of a cylindrical can 10. Alternatively, the other way around may apply.

The electrode assembly 20, an upper insulation plate 12, and a lower insulation plate (not shown) are sequentially inserted into the can 10 through an opening of the can 10. The upper insulation plate 12 and the lower insulation plate are installed in upper and lower portions of the can 10, respectively. A outer wall in the upper portion of the can 10 is pressed toward the center thereof to form a beading portion 14. That is, the beading portion 14 is recessed from the outer wall of the can 10. The beading portion 14 prevents the electrode assembly 20 from moving within the can 10. In addition, electrolyte is injected into the can 10. A gasket 30 for insulation is installed on the beading portion 14 and inside the can 10. A cap assembly 40 for closing the opening of the can 10 is installed above the beading portion 14. The cap assembly 40 includes a vent welded to the positive electrode tap 22, a current interrupt device (CID), a positive thermal coefficient (PTC) device, and a cap up having an electrode terminal. The vent of the cap assembly 40 is supported by the beading portion 14 and thus prevented from moving downward. Finally, a clamping process is performed. That is, as a stopper, the cap up inserted into the gasket 30 is pushed into the opening of the cylindrical can 10, thereby closing the can 10.

The conventional cylindrical secondary battery configured as described above has the following problems.

When the cap assembly 40 is coupled to the upper portion of the can 10, components of the cap assembly 40 must be sequentially installed, which increases the time required to assemble the cylindrical secondary battery. Consequently, it takes too much time and costs to manufacture the cylindrical secondary battery.

When the cylindrical secondary battery is manufactured using the clamping process in which the can 10 is pressed against the gasket 30, it cannot have a structure resistant to a high pressure of 30 kgf/cm2 or greater.

After the clamping process, a flash plating process must be additionally performed on an upper end of the non-plated can 10.

When the can 10 is pressed toward the center thereof to form the beading portion 14, a metal material of the can 10 may flow into the can 10. If the metal foreign matter flows into the can 10, it may cause severe safety-related defects. In particular, these defects are major causes of recent notebook battery explosions.

Furthermore, the space occupied by the beading portion 14 is inefficiently utilized. If the beading portion 14 can be removed, more electrode assembly 20 and electrolyte can be inserted into the space occupied by the beading portion 14, can be increased. Then, the electric capacity of the cylindrical secondary battery can be increased that much.

### DISCLOSURE OF INVENTION

### Technical Problem

The present invention provides a cylindrical secondary battery and a method of manufacturing the same, in which an assembling process is significantly simplified, and thus the time and costs required to manufacture the cylindrical secondary battery are reduced.

The present invention also provides a cylindrical secondary battery and a method of manufacturing the same, in which the process of forming a beading portion is removed in order to prevent metal foreign matter from flowing into a can and thus make the cylindrical secondary battery safer.

The present invention also provides a cylindrical secondary battery and a method of manufacturing the same, in which a beading portion is not formed, and the space that could have been occupied by a beading portion is used to increase the electric capacity of the cylindrical secondary battery.

However, objectives of the present invention are not restricted to the one set forth herein. The above and other objectives of the present invention will become more apparent to one of ordinary skill in the art to which the present invention pertains by referencing the detailed description of the present invention given below.

### Technical Solution

According to an aspect of the present invention, there is provided a cylindrical secondary battery including a cylindrical exterior can having an open top portion into which an electrode assembly and electrolyte can be inserted and having an electrode tap which is drawn from the electrode assembly and extends upward; and a cap assembly assembled as an integrated structure, having an outer side surface welded and fixed to an inner side surface of an upper portion of the exterior can, and having a bottom surface joined and electrically connected to the electrode tap to transmit electric current generated by the electrode assembly to the outside.

The cap assembly may include a sub disc joined and electrically connected to the electrode tap; a safety vent having a connection portion which protrudes downward from the center of a bottom surface thereof and is joined and electrically connected to the sub disc; a cap up electrically connected to a top surface of the safety vent and the outside; a gasket pressing and supporting the rim of the cap up and that of the safety vent and insulating the cap up and the safety vent from the outside; and an outer case pressing and supporting an outer surface of the gasket and welded to the inner side surface of the upper portion of the exterior can, wherein the connection portion of the safety vent is separated from the sub disc when pressure within the exterior can exceeds a predetermined level.

According to another aspect of the present invention, there is provided a method of manufacturing a cylindrical secondary battery. The method includes assembling a cap assembly as an integrated structure; inserting an electrode assembly and electrolyte into a cylindrical exterior can having an open top portion; joining and electrically connecting an electrode tap, which is drawn from the electrode assembly, to a bottom surface of the cap assembly; inserting the cap assembly into the open top portion of the exterior can and thus bending the electrode tap; and welding an outer side surface of the cap assembly to an inner side surface of an upper portion of the exterior can.

The assembling of the cap assembly may include joining and electrically connecting a connection portion, which protrudes downward from the center of a safety vent, to a sub disc; stacking a cap up on the safety vent; stacking a gasket on the cap up to accommodate the safety vent and the cap up in the gasket; and pressing lower portions of an outer case and the gasket toward the centers thereof.

### BRIEF DESCRIPTION OF THE DRAWINGS

FIG. 1 is a cross-sectional view of a conventional cylindrical secondary battery;

FIG. 2 is a cross-sectional view of a cylindrical secondary battery according to the present invention;

FIGS. 3 and 4 are exploded perspective views of a cap assembly included in the cylindrical secondary battery of FIG. 2;

FIG. 5 is a cross-sectional view for explaining a process of assembling the cap assembly included in the cylindrical secondary battery of FIG. 2;

FIG. 6 is a cross-sectional view of the cap assembly assembled as an integrated structure and included in the cylindrical secondary battery of FIG. 2;

FIG. 7 is a cross-sectional view for explaining a process of coupling the cap assembly to an exterior can in the cylindrical secondary battery of FIG. 2; and

FIG. 8 is a cross-sectional view for explaining a process of blocking the flow of electric current in the cylindrical secondary battery of FIG. 2.

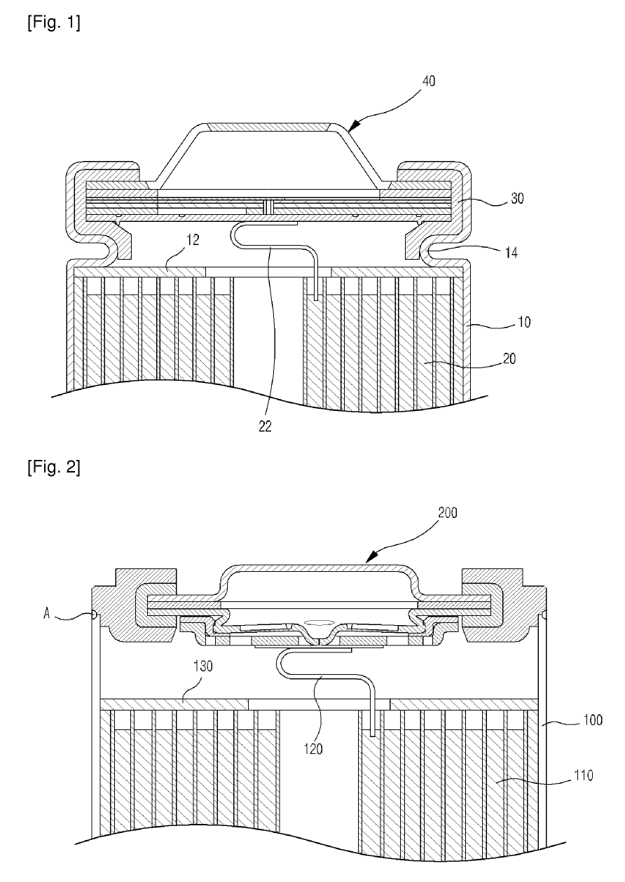

### EXPLANATION OF REFERENCE NUMERALS DESIGNATING THE MAJOR ELEMENTS OF THE DRAWINGS

100: exterior can 110: electrode assembly
120: electrode tap 130: upper insulation plate
200: cap assembly 210: cap up
220: positive thermal coefficient (PTC) device 230: safety vent
232: connection portion 240: insulation plate
250: cap down 252: through-hole
254, 256: hole 260: sub disc
270: gasket 280: outer case
282: can-welding portion

### BEST MODE FOR CARRYING OUT THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

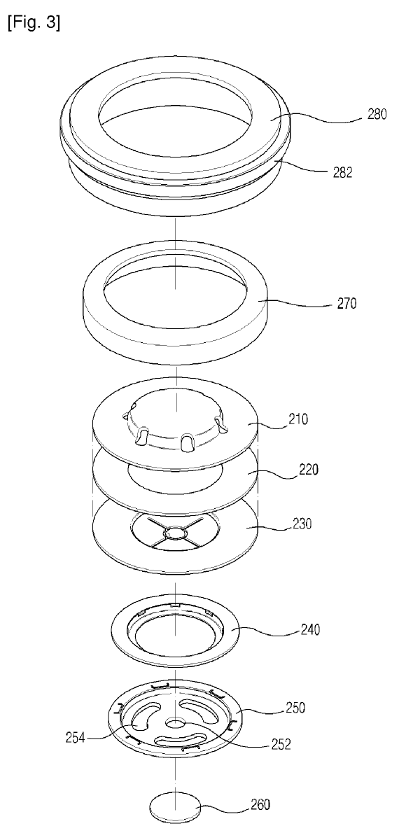

FIG. 2 is a cross-sectional view of a cylindrical secondary battery according to the present invention.

Referring to FIG. 2, the cylindrical secondary battery according to the present invention includes an exterior can 100 and a cap assembly 200. The exterior can 100 is cylindrical, and a top portion of the exterior can 100 is open so that an electrode assembly 110 and electrolyte can be inserted into the exterior can 100 through the open top portion of the exterior can 100. The cap assembly 200 is assembled as an integrated structure and then coupled to an upper portion of the exterior can 100.

More specifically, the electrode assembly 110 includes an anode plate, a cathode plate, and a separator. The anode plate has an anode active material layer coated on a surface of an anode collector, and the cathode plate has a cathode active material layer coated on a surface of a cathode collector. In addition, the separator is interposed between the anode plate and the cathode plate and electrically insulates the anode plate and the cathode plate from each other. The anode plate, the cathode plate and the separator are rolled up like a jellyroll to form the electrode assembly 110. An electrode tap 120 protrudes upward from an upper end of the electrode assembly 110 and is welded and thus electrically connected to a bottom surface of the cap assembly 200.

The exterior can 100 has a cylindrical structure in which a predetermined space is formed to receive the electrode assembly 110 and the electrolyte. While a bottom portion of the exterior can 100 is closed, the top portion of the exterior can 100 is open to allow the cap assembly 200 to be coupled thereto. In addition, an upper insulation plate 130 and a lower insulation plate (not shown) may be installed in the upper and lower portions of the exterior can 100, respectively, in order to prevent the electrode assembly 110 from contacting the cap assembly 200 and the exterior can 100.

The cap assembly 200 is assembled as an integrated structure and then inserted into the top portion of the exterior can 100. In addition, an outer side surface of the cap assembly 200 is welded to an inner side surface of the upper portion of the exterior can 100. That is, after the cap assembly 200 is inserted into the open top portion of the exterior can 100, the outer side surface of the cap assembly 200 is laser-welded to the inner side surface of the upper portion of the exterior can 100. Consequently, the cap assembly 200 seals up the top portion of the exterior can 100. Here, while the bottom surface of the cap assembly 200 is joined and thus electrically connected to the electrode tap 120, the cap assembly 200 may be insulated from the exterior can 100. The cap assembly 200 transmits electric current generated by the electrode assembly 110 to an external device.

The structure of the cap assembly 200 will now be described in more detail.

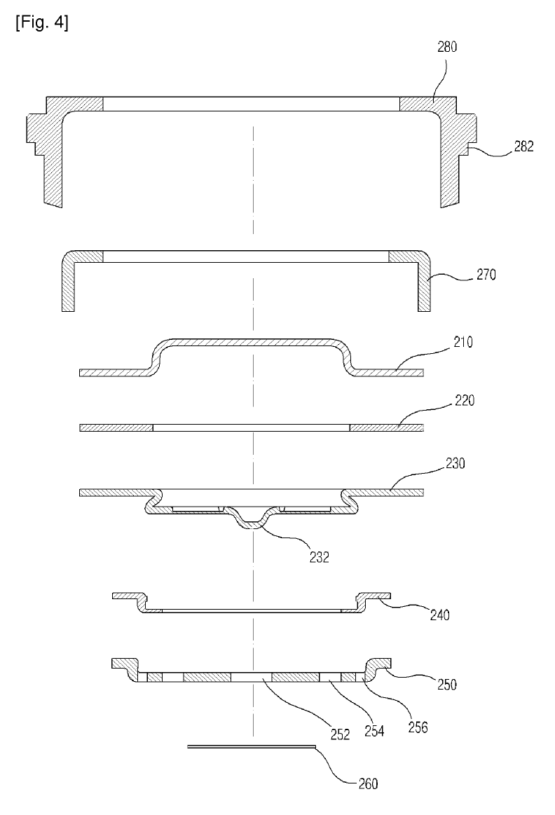

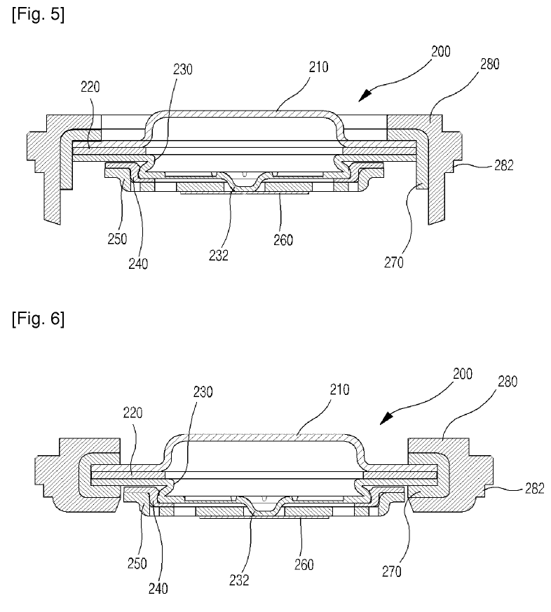

FIGS. 3 and 4 are exploded perspective views of the cap assembly 200 included in the cylindrical secondary battery of FIG. 2. FIG. 5 is a cross-sectional view for explaining a process of assembling the cap assembly 200 included in the cylindrical secondary battery of FIG. 2. FIG. 6 is a cross-sectional view of the cap assembly 200 assembled as an integrated structure and included in the cylindrical secondary battery of FIG. 2.

Referring to FIGS. 3 through 6, the cap assembly 200 according to the present invention includes a sub disc 260, through which electric current generated by the electrode assembly 110 flows to the external device, a safety vent 230, a cap up 210, a gasket 270, which is used to assemble the sub disc 260, the safety vent 230 and the cap up 210, and an outer case 280.

The sub disc 260 is disposed at the bottom of the cap assembly 200 assembled as an integrated structure. The sub disc 260 is joined and thus electrically connected to the electrode tap 120 which is drawn upward from the electrode assembly 110. The sub disc 260 is made of a conductive metal material.

The safety vent 230 functions as a first safety device of the cylindrical secondary battery according to the present invention. That is, when the pressure in the exterior can 100 exceeds a predetermined level, the safety vent 230 blocks the flow of electric current within the cylindrical secondary battery in order to prevent the explosion of the cylindrical secondary battery. The safety vent 230 is made of a conductive metal material. An upper rim of the safety vent 230 extends in an outward direction to be supported by the gasket 270 which will be described later. In addition, the safety vent 230 has a contact portion 232 at the center of a bottom surface thereof. The contact portion 232 is joined and electrically connected to the sub disc 260 and protrudes downward from the center of the bottom surface of the safety vent 230.

That is, when the cylindrical secondary battery is in a normal state, electric current generated by the electrode assembly 110 flows to the external device via the electrode tap 120, the sub disc 260, the safety vent 230, and then the cap up 210. However, when the pressure in the cylindrical secondary battery abnormally increases due to overcharging or abnormal heat generation of the cylindrical secondary battery as illustrated in FIG. 8, the contact portion 232 of the safety vent 230 is separated from the sub disc 260. As a result, the flow of electric current in the cylindrical secondary battery is blocked, thereby securing the safety of the cylindrical secondary battery.

A region around the contact portion 232 of the safety vent 230 may be thinner than the other regions of the bottom surface of the safety vent 230 so that the contact portion 232 can be readily elevated and thus separated from the sub disc 260 when the pressure within the cylindrical secondary battery abnormally increases.

The cap up 210 is disposed in an upper portion of the cap assembly 200 and transmits electric current generated by the cylindrical secondary battery to the external device. The cap up 210 is the same size as a top surface of the safety vent 230 and is joined and electrically connected to the top surface of the safety vent 230. That is, when the rim of a bottom surface of the cap up 210 contacts the rim of the top surface of the safety vent 230, the cap up 210 and the safety vent 230 are pressed against each other by the gasket 270 and the outer case 280. As a result, the cap up 210 and the safety vent 230 are joined and electrically connected to each other.

The gasket 270 presses and supports the rim of the cap up 210 and that of the safety vent 230. In addition, the gasket 270 insulates the cap up 210 and the safety vent 230 from the outside. The gasket 270 has a cylindrical structure in which the safety vent 230 and the cap up 210 can be accommodated. A bottom portion of the gasket 270 is open so that the safety vent 230 and the cap up 210 can be inserted thereinto. A top surface of the gasket 270 protrudes to a predetermined length from the rim of the gasket 270 toward the center thereof and contacts the rim of the top surface of the cap up 210. When the cap assembly 200 is assembled, the safety vent 230 and the cap up 210 are sequentially stacked, and then the gasket 270 is stacked on the cap up 210. After the gasket 270 is stacked on the cap up 210 to accommodate the safety vent 230 and the cap up 210, a lower portion of the gasket 270 is pressed toward the center thereof. Then, the safety vent 230 and the cap up 210 are fixed and electrically connected to each other. Here, the gasket 270 is not pressed in a separate process. Instead, the gasket 270 is pressed together with the outer case 280 which will be described later.

The outer case 280 forms an outer side surface of the cap assembly 200. The outer case 280 presses and supports an outer surface of the gasket 270 and is welded to the inner side surface of the upper portion of the exterior can 100. The outer case 280 has a cylindrical structure in which the gasket 270 can be received. A bottom portion of the outer case 280 is open so that the gasket 270, the safety vent 230 and the cap up 210 can be inserted thereinto. In addition, a top surface of the outer case 280 protrudes to a predetermined length from the rim of the outer case 280 toward the center thereof and contacts the top surface of the gasket 270. When the cap assembly 200 is assembled, the safety vent 230, the cap up 210 and the gasket 270 are sequentially stacked, and then the outer case 280 is stacked on the gasket 270. After the outer case 280 is stacked on the gasket 270 to accommodate the safety vent 230, the cap up 210 and the gasket 270, a lower portion of the outer case 280 is pressed toward the center thereof. Then, the outer case 280, the gasket 270, the safety vent 230 and the cap up 210 are assembled as an integrated structure.

The cap assembly 200 can better resist an abnormal increase of pressure in the cylindrical secondary battery when the lower portions of the gasket 270 and the outer case 280 are pressed toward the centers thereof as described above than when upper portions of the gasket 270 and the outer case 280 are pressed toward the centers thereof.

A concave can-welding portion 282 is formed along an outer circumferential side surface of the outer case 280. The can-welding portion 282 is welded to the inner side surface of the upper portion of the exterior can 100. The can-welding portion 282 may be formed to a depth corresponding to a thickness of the exterior can 100. After an upper end of the exterior can 100 is inserted into the can-welding portion 282, a point A, at which the can-welding portion 282 contacts the upper end of the exterior can 100, is laser-welded in a circumferential direction the exterior can 100. Consequently, the outer case 280 is joined to the exterior can 100. In order to easily weld the outer case 280 to the exterior can 100, the outer case 280 and the exterior can 100 may be made of the same metal.

The cap assembly 200 according to the present invention may further include a positive temperature coefficient (PTC) device 220 which insulates the safety vent 230 from the cap up 210 when the temperature of the cylindrical secondary battery exceeds a predetermined level. The PTC device 220 is shaped like a ring whose outer diameter corresponds to an outer diameter of the safety vent 230 and is inserted between the safety vent 230 and the cap up 210. That is, after the safety vent 230, the PTC device 220 and the cap up 210 are sequentially stacked within the gasket 270, they are pressed and fixed together with other components when the outer case 280 is pressed.

The PTC device 220 functions as a second safety device of the cylindrical secondary battery. That is, when the temperature of the cylindrical secondary battery is normal, the PTC device 220 electrically connects the safety vent 230 to the cap up 210. However, when the temperature of the cylindrical secondary battery abnormally increases, the PTC device 220 blocks the flow of electric current within the cylindrical secondary battery. The PTC device 220 includes a device layer, which is made of resin and carbon powder, and a conductive plate coupled to top and bottom surfaces of the device layer. When the temperature of the PTC device 220 increases, the resin of the device layer expands and cuts the connection of the carbon powder. As a result, the flow of electric current is blocked. A ceramic device may be used as the PTC device 220.

The cap assembly 200 according to the present invention may further include a cap down 250 and an insulation plate 240 for supporting the safety vent 230 and the sub disc 260.

The cap down 250 is installed between the sub disc 260 and the safety vent 230 and welded to the sub disc 260, thereby fixing the sub disc 260. The cap down 250 is a disc made of a metal material. The cap down 250 has a through-hole 252 at the center thereof, and the contact portion 232 of the safety vent 230 penetrates through the through-hole 252. In addition to the though-hole 252, the cap down 250 may have a plurality of holes 254 and 256 in a bottom surface thereof. Accordingly, the pressure generated in the cylindrical secondary battery may be delivered to the safety vent 230 through the holes 254 and 256.

The insulation plate 240 is received into the cap down 250 and insulates the safety vent 230 from the cap down 250. The insulation plate 240 is ring-shaped and thus connected to the through hole 252 of the cap down 250. The contact portion 232 of the safety vent 230 passes through the insulation plate 240 and the cap down 250 and is joined to the sub disc 260. A lower rim of the safety vent 230 is force-fitted into the insulation plate 240, and the insulation plate 240 is also force-fitted into the cap down 250. A plurality of protrusions (not shown) may be formed on an outer circumferential surface of the insulation plate 240 to allow the insulation plate 240 to be coupled to the cap down 250.

Referring to FIGS. 3 through 6, the cap assembly 200 configured as described above is assembled as follows.

First of all, the insulation plate 240 is force-fitted onto a lower portion of the safety vent 230. Then, the cap down 250 is force-fitted onto a lower portion of the insulation plate 240. Here, the contact portion 232 of the safety vent 230 passes through the insulation plate 240 and the cap down 250. Next, the sub disc 260 is welded and electrically connected to the contact portion 232 of the safety vent 230. The sub disc 260 may also be welded and thus fixed to the cap down 250.

The PTC device 220 and the cap up 210 are sequentially stacked on the safety vent 230 assembled with the sub disc 260 and the like as described above. The PTC device 220 may be omitted when necessary.

Next, the gasket 270 is stacked on the cap up 210. As a result, the safety vent 230, the PTC device 220 and the cap up 210 are received into the cylindrical gasket 270. In this case, the top surface of the gasket 270 contacts the rim of the top surface of the cap up 210.

The outer case 280 is stacked on the gasket 270. As a result, the gasket 270 is received into the cylindrical outer case 280, and the top surface of the outer case 280 contacts the top surface of the gasket 270. If the gasket 270 and the outer case 280 are sequentially stacked on the safety vent 230, the cap up 210 and the like, the resultant structure is as illustrated in FIG. 5.

In this state, the lower portions of the outer case 280 and the gasket 270 are pressed toward the centers thereof. Then, the cap assembly 200 is completed as illustrated in FIG. 6. Since both of the gasket 270 and the outer case 280 are cylindrical, they may cease when the lower portions of the outer case 280 and the gasket 270 are pressed toward the centers thereof. In order to prevent the formation of creases in the gasket 270 and the outer case 280, the process of pressing the lower portions of the gasket 270 and the outer case 280 may be performed through a number of steps while heat is applied to the gasket 270 and the outer case 280.

The process of coupling the cap assembly 200 to the exterior can 100 will now be described.

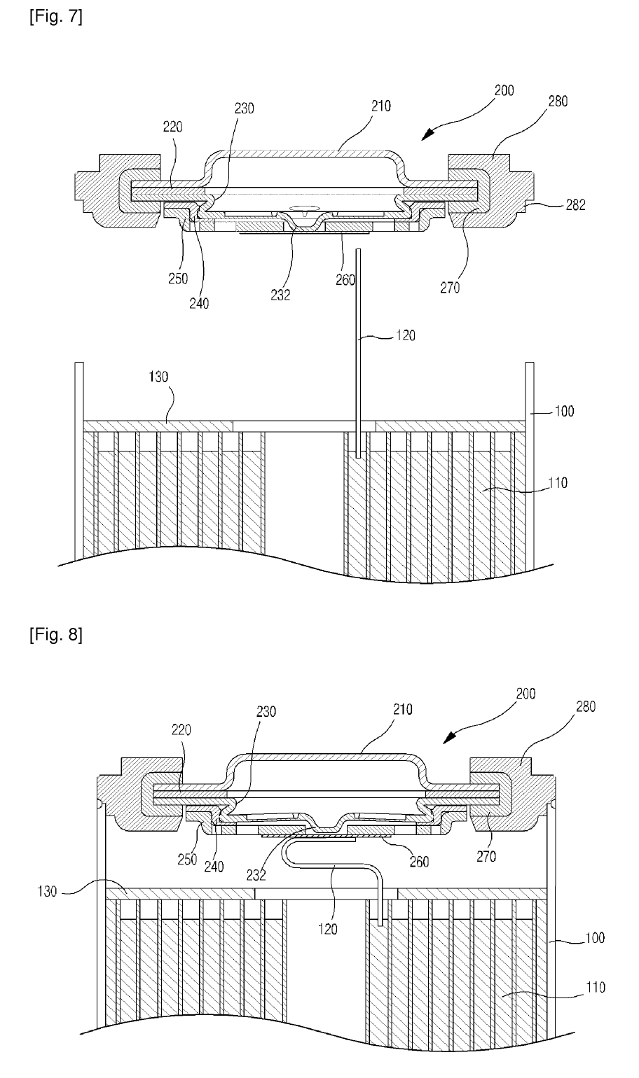

FIG. 7 is a cross-sectional view for explaining a process of coupling the cap assembly 200 to the exterior can 100 in the cylindrical secondary battery of FIG. 2

Referring to FIG. 7, the electrode assembly 110 and electrolyte are inserted into the cylindrical exterior can 100 with the open top portion. Before and after the electrode assembly 110 and the electrolyte are inserted into the exterior can 100, the lower insulation plate and the upper insulation plate 130 are inserted into the exterior can 100 in order to prevent the electrode assembly 110 and the electrolyte from directly contacting the bottom surfaces of the cap assembly 200 and the exterior can 100. The lower insulation plate is installed as a disc without a through-hole at the center thereof, and the upper insulation plate 130 is installed as a disc having a through-hole through which the electrode tap 120 penetrates. The electrode tap 120 drawn upward from the upper end of the electrode assembly 110 extends beyond the upper insulation plate 130 through the through-hole of the upper insulation plate 130.

Then, the electrode tap 120 is joined and thus electrically connected to the bottom surface of the cap assembly 200 assembled as an integrated structure in advance, that is, the bottom surface of the sub disc 260.

In this state, if the cap assembly 200 is inserted into the exterior can 100, the electrode tap 120 is bent as illustrated in FIG. 2.

After the cap assembly 200 is inserted into the open top portion of the exterior can 100, the upper end of the exterior can 100 is inserted into the outer side surface of the cap assembly 200, that is, the concave can-welding portion 282 formed on the outer side surface of the outer case 280. In this state, the point A at which the can-welding portion 282 contacts the upper end of the exterior can 100 is laser-welded in the circumferential direction of the cylindrical secondary battery. As a result, the cylindrical secondary battery according to the present invention is completed. Then, a tubing process is performed to coat the exterior of the cylindrical secondary battery with an exterior material.

Although the cylindrical secondary battery has been described above, the present invention can also be applied to secondary batteries of other shapes.

While the present invention has been particularly shown and described with reference to exemplary embodiments thereof, it will be understood by those of ordinary skill in the art that various changes in form and detail may be made therein without departing from the spirit and scope of the present invention as defined by the following claims.

### INDUSTRIAL APPLICABILITY

In a cylindrical secondary battery and a method of manufacturing the same according to the present invention, a cap assembly is assembled as an integrated structure in advance, and then coupled to an exterior can. Therefore, the time required to assemble the cylindrical secondary battery is reduced.

Unlike a conventional cylindrical secondary battery, the cylindrical secondary battery according to the present invention does not include a beading portion in the exterior can. Therefore, the time required to manufacture the cylindrical secondary battery can be reduced by the time required to form the beading portion. In addition, since the beading portion is not formed, there is no concern that a metal material of the beading portion may flow into the exterior can. Consequently, the safety of the cylindrical secondary battery can be improved.

Since more electrode assembly and electrolyte are inserted into the exterior can, can be increased by the space that could have been occupied by the beading portion, the electric capacity of the cylindrical secondary battery can be increased too much.

According to the present invention, the cap assembly is laser-welded to the exterior can. Therefore, the cylindrical secondary battery according to the present invention can resist higher pressure than the conventional cylindrical secondary battery manufactured using a conventional clamping process.

Furthermore, unlike the conventional art in which a flash plating process must be performed on an upper end of a non-plated can after the clamping process, the present invention does not require the flash plating process.

1. A cylindrical secondary battery comprising:
a cylindrical exterior can having an open top portion into which an electrode assembly and electrolyte can be inserted and having an electrode tap which is drawn from the electrode assembly and extends upward; and
a cap assembly assembled as an integrated structure, having an outer side surface welded and fixed to an inner side surface of an upper portion of the exterior can, and having a bottom surface joined and electrically connected to the electrode tap to transmit electric current generated by the electrode assembly to the outside.

2. The battery of claim 1, wherein the cap assembly comprises:
a sub disc joined and electrically connected to the electrode tap;
a safety vent having a connection portion which protrudes downward from the center of a bottom surface thereof and is joined and electrically connected to the sub disc;
a cap up electrically connected to a top surface of the safety vent and the outside;
a gasket pressing and supporting the rim of the cap up and that of the safety vent and insulating the cap up and the safety vent from the outside; and
an outer case pressing and supporting an outer surface of the gasket and welded to the inner side surface of the upper portion of the exterior can,
wherein the connection portion of the safety vent is separated from the sub disc when pressure within the exterior can exceeds a predetermined level.

3. The battery of claim 2, wherein a concave can-welding portion is formed along an outer circumferential side surface of the outer case, is welded to the inner side surface of the upper portion of the exterior can, and is formed to a depth corresponding to a thickness of the exterior can.

4. The battery of claim 2 or 3, wherein the cap assembly further comprises a positive thermal coefficient (PTC) device inserted between the safety vent and the cap up and insulating the safety vent from the cap up when the temperature of the cylindrical secondary battery exceeds a predetermined level.

5. The battery of claim 2 or 3, wherein the cap assembly further comprises:
a cap down installed between the sub disc and the safety vent, welded to the sub disc, and having a through-hole, through which the connection portion of the safety vent penetrates, at the center thereof; and
an insulation plate received into the cap down, insulating the safety vent from the cap down, and shaped like a ring to be connected to the through-hole of the cap down.

6. The battery of claim 5, wherein the cap down has a plurality of holes in a bottom surface thereof to allow pressure generated in the cylindrical secondary battery to be transmitted to the safety vent.

7. The battery of claim 5, wherein a lower rim of the safety vent is force-fitted into the insulation plate, and the insulation plate is force-fitted into the cap down.

8. A method of manufacturing a cylindrical secondary battery, the method comprising:
assembling a cap assembly as an integrated structure;
inserting an electrode assembly and electrolyte into a cylindrical exterior can having an open top portion;
joining and electrically connecting an electrode tap, which is drawn from the electrode assembly, to a bottom surface of the cap assembly;
inserting the cap assembly into the open top portion of the exterior can and thus bending the electrode tap; and
welding an outer side surface of the cap assembly to an inner side surface of an upper portion of the exterior can.

9. The method of claim 8, wherein the assembling of the cap assembly comprises:
joining and electrically connecting a connection portion, which protrudes downward from the center of a safety vent, to a sub disc;
stacking a cap up on the safety vent;
stacking a gasket on the cap up to accommodate the safety vent and the cap up in the gasket; and
pressing lower portions of an outer case and the gasket toward the centers thereof.

10. The method of claim 9, wherein the assembling of the cap assembly further comprises interposing a PTC device between the safety vent and the cap up.

11. The method of claim 9 or 10, wherein the assembling of the cap assembly comprises:
inserting a lower rim of the safety vent into an insulation plate before joining the connection portion of the safety vent to the sub disc;
inserting the insulation plate into a cap down; and
welding the sub disc to the cap down.
